(19) United States
(12) Patent Application Publication
(10) Pub. No.: US 2013/0126534 A1
(43) Pub. Date: May 23, 2013

(54) Tank With Inclined Walls

(71) Applicants: Arne Barrett Sele, Hosle (NO); Trygve Johannes Lund, Oslo (NO)

(72) Inventors: Arne Barrett Sele, Hosle (NO); Trygve Johannes Lund, Oslo (NO)

(73) Assignee: AKER ENGINEERING & TECHNOLOGY AS, Lysaker (NO)

(21) Appl. No.: 13/505,258

(22) PCT Filed: Oct. 28, 2010
(86) PCT No.: PCT/NO10/00386

§ 371 Date: Sep. 20, 2012

(30) Foreign Application Priority Data
Oct. 29, 2009 (NO) 20093241
Jul. 2, 2010 (NO) 20100967

(51) Int. Cl. F17C 1/00

(52) U.S. Cl. CPC F17C 1/002
USPC 220/562

(57) ABSTRACT

The present invention concerns a substantially prismatic tank (1) for the transportation and storage of fluids comprising a bottom and a first (10) and second pair of opposite side walls, both pair of walls joined to said bottom, wherein the first pair of side walls are inclined with an obtuse angle with respect to the bottom, said first pair of side walls having a height of more than half the total height of the tank, and the second pair of side walls have a substantially straight angle with respect to the bottom.

### FIELD OF INVENTION

The present invention relates to tanks for storage and transportation of fluids such as hydrocarbons, including low temperature liquefied natural gas. This includes tanks for ships and floating offshore structures exposed to wave loads.

### BACKGROUND OF THE INVENTION

Tanks for carrying liquefied gas in bulk are most simply designed as spheres, cylinders with curved ends or made up from straight panels. Prismatic tanks may incorporate upper or lower hoppers, or both, in order to achieve a close fit to the hull. Due to healing and dynamic load arising from waves as well as the gravity load of the structure, in plane loads will be set up in the walls of the tank. Loads in the vertical wall will not be effectively supported by the hopper which is flexible in its transverse direction. Due to the in plane rigidity of the tanks vertical side wall, the vertical load will be absorbed by transverse walls or web frames. This causes large load concentrations in these elements and in their supports or alternatively necessitates inclined supports at the upper knee of the hopper which are very cumbersome to construct.

### OBJECT OF THE INVENTION

The object of the present invention is a tank configuration of more simple geometry which is easier to construct. This in particular applies if the tank is made up from extruded or rolled cross sections. An important advantage gained from this shape is that in plane loads in the walls are supported directly on the bottom with timber supports, without introducing bending of wall panels or having to provide supports at the upper knee of the lower hopper.

### SUMMARY OF THE INVENTION

The object of the present invention is obtained by making the tank of a hexagonal configuration with frames and wing tanks of a trapezoidal shape. This provides the same cross sectional area, cargo capacity and ballast capacity as current configurations, while at the same time minimizing load on the internal web frames. The present invention comprises the following:

A substantially prismatic tank 1 for the transportation and storage of fluids comprising a bottom and a first and second pair of opposite side walls joined to said bottom, wherein the first pair of side walls are inclined with an obtuse angle with respect to the bottom, said first pair of side walls having a height, equal to, or more than, half the total height of the tank, and the second pair of side walls have a substantially straight angle with respect to the bottom.

In the tank according to the present invention, the obtuse angle is preferably within the range of 95-105° and even more preferred within 96-100°.

In the tank according to the present invention, the ratio of the height of the inclined side walls and the total height of the tank is preferably within 0.5-0.9, even more preferred within 0.6-0.8.

Preferably, in the tank according to the present invention, the first vertical cross section is hexagonal and the second vertical cross section, perpendicular to said first cross section, is rectangular.

In the context of this invention, the term “total height of the tank” is not intended to include the added height of, for instance, a dome structure for piping and wiring on the roof of the tank, but only the height measured from the bottom of the tank up to the roof of the tank.

In the context of this invention, the term “substantially straight angel” is intended as an angle between 87-93°, preferably between 89-91°.

### BRIEF DESCRIPTION OF THE DRAWINGS

Further details of the invention will be described below with reference to the exemplifying embodiments shown schematically in the appended drawings, wherein:

FIG. 1 shows the longitudinal cross section of a gas carrier.

FIG. 2 shows the cross section of the tank with inclined faces indicated in FIG. 1.

FIG. 3 shows an isometric view of a tank with inclined walls and an upper hopper.

FIG. 4 shows a cross section of a vessel with a tank having a configuration used in prior art designs.

FIG. 5 shows a part of a cross section of a tank having a configuration used in prior art designs.

FIG. 6 shows a part of a cross section of a tank having a configuration according to the present invention.

### DETAILED DESCRIPTION OF THE DRAWINGS

FIG. 1 shows a longitudinal section of a gas carrier with prismatic tanks 1 and bulkheads 5 which may be designed as tanks for ballast or for other liquid cargo.

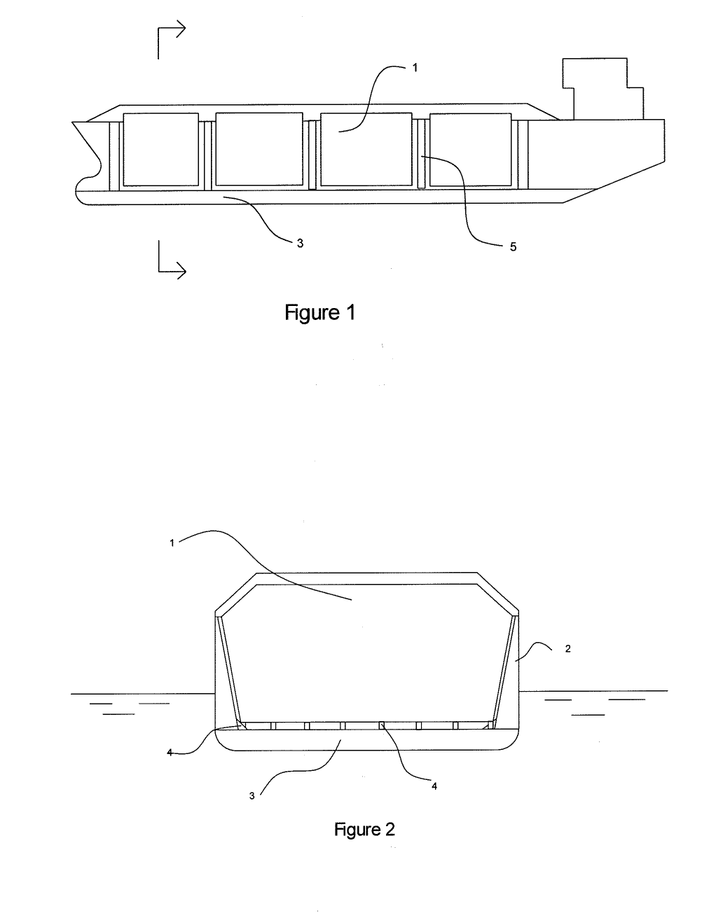

FIG. 2 depicts the cross section indicated in FIG. 1 in which the prismatic tanks 1 shown in FIG. 1 is shown to have a hexagonal cross section. This tank mates with wing tanks 2 with a cross section shaped as a parallelogram as well as a double bottom 3. FIG. 2 also shows supports 4 including supports immediately below the inclined side walls. The wing tanks 2 and the tanks in the double bottom 3 accommodate ballast.

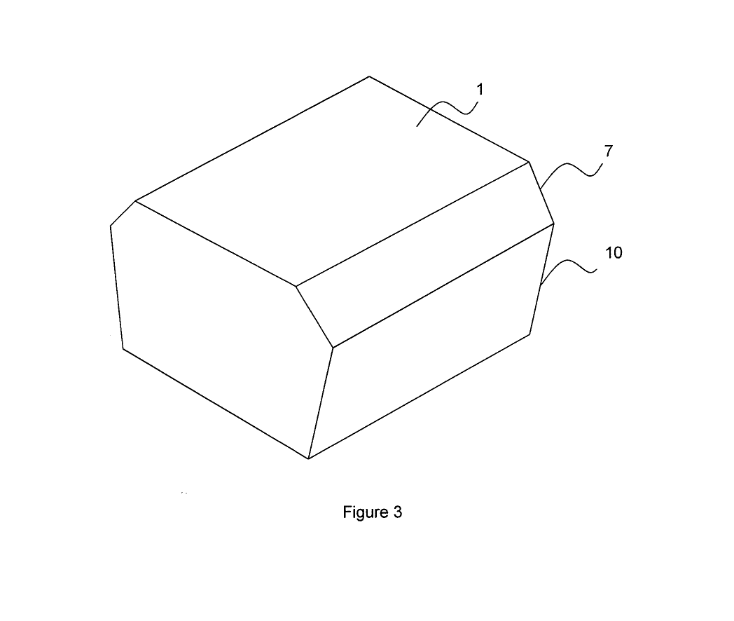

FIG. 3 shows an isometric view of a tank 1 with inclined walls 10 and an upper hopper 7.

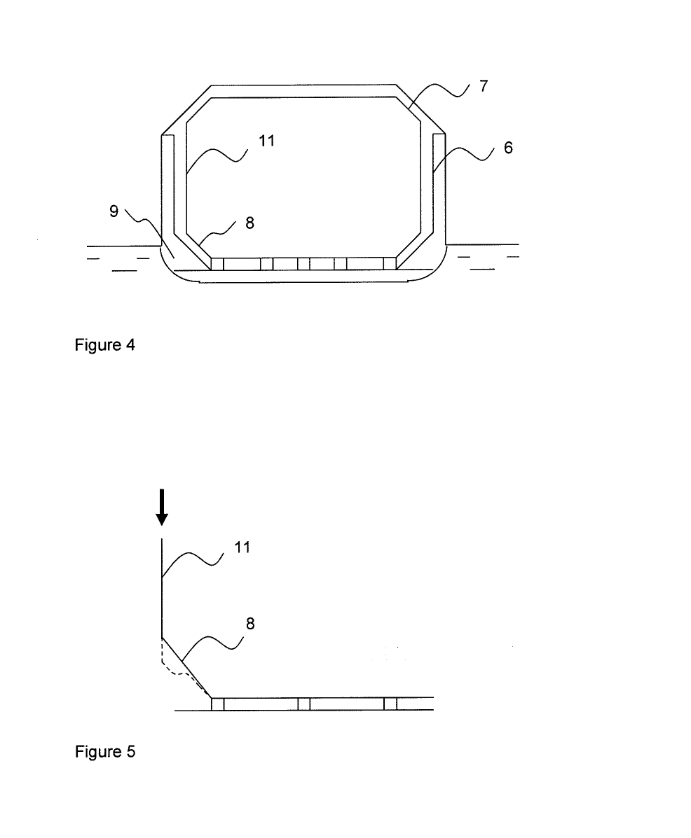

FIG. 4 shows a cross section of a vessel with a tank incorporating upper 7 and lower hoppers 8 which is the current configuration used in design of such vessels. The vertical side walls 11 of the tank are parallel to the walls of the wing tanks 6 which incorporate the web frame. These web frames incorporates haunches 9 which reinforce the web frames at the corner where these are heavily loaded.

The significant issue in this context is that loads in the plane of a wall provide very rigid support. Loads transverse to the plane of a wall provide very flexible support. The vertical load in the plane of side wall 11 experiences very flexible support from the hopper 8.

FIG. 5 illustrates (in an exaggerated fashion) how the vertical in plane load (illustrated as an arrow) in the side walls 11 of a tank of current design will cause the lower hoppers 8 to experience excessive deformation (illustrated by the broken line) and distress in the lower hopper section when this is constructed from elements with low lateral bending strength such as horizontally spanning beams. This in turn transfers greater load to the internal web frames and may overload their supports.

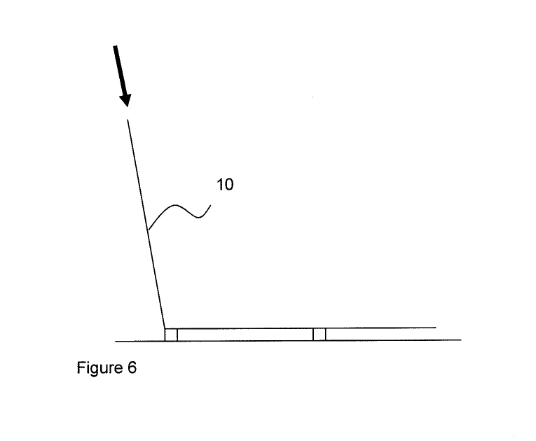

FIG. 6 illustrates how an inclined wall 10, of a tank according to the present invention, with an in plane load will bear directly onto the supports.

1. A substantially prismatic tank for the transportation and storage of fluids comprising a bottom and a first and second pair of opposite side walls, both pair of walls being joined to said bottom, where the first pair of side walls are inclined with an obtuse angle with respect to the bottom, and the second pair of side walls have a substantially straight angle with respect to the bottom, wherein the obtuse angle is within the range of 95-105° and the first pair of side walls have a height equal to, or more than, half the total height of the tank.

2. (canceled)

3. A tank according to claim 1, wherein the ratio of the height of the inclined side walls and the total height of the tank is within 0.5-0.9.

4. A tank according to claim 1, wherein the tank has a first vertical cross section which is hexagonal and a second vertical cross section, perpendicular to said first cross section, which is rectangular.

5. A tank according to claim 1, wherein the tank is resting directly on the bottom without supports at an upper knee of a lower hopper.
